(19) United States
(12) Patent Application Publication
(10) Pub. No.: US 2018/0005312 A1
(43) Pub. Date: Jan. 4, 2018

(54) Virtual-Reality Apparatus and Methods Thereof

(71) Applicant: Wal-Mart Stores, Inc., Bentonville, AR (US)

(72) Inventors: Todd D. Mattingly, Bentonville, AR (US); David Tovey, Rogers, AR (US); Nicholas R. Antel, Springdale, AR (US); John J. O'Brien, Farmington, AR (US)

(21) Appl. No.: 15/622,686

(22) Filed: Jun. 14, 2017

Related U.S. Application Data
(60) Provisional application No. 62/356,381, filed on Jun. 29, 2016.

(51) Int. Cl. G06Q 30/06; G06F 3/16; G06F 3/01

(52) U.S. Cl. CPC G06Q 30/0643; G06Q 30/0631; G06Q 30/0623; G06F 3/011; G06F 3/016; G06F 3/167

(57) ABSTRACT

In some embodiments, apparatuses and methods are provided herein useful to provide experiential on-site use of physical products within a retail shopping facility in a combined virtual and physical setting. In some embodiments, a customer may use a physical retail product within the retail shopping facility in an environment simulated to be similar to those typically used or recommended for use with the physical retail product. Thus, for certain items that cannot be easily experienced in a retail shopping facility, the systems, apparatuses, and methods herein provide for a manner of experiencing a physical retail product before purchase. The combined virtual-physical experience may serve as a retail marketing system.

### CROSS-REFERENCE TO RELATED APPLICATION

This application claims the benefit of U.S. Provisional Application No. 62/356,381, filed Jun. 29, 2016, which is incorporated herein by reference in its entirety.

### TECHNICAL FIELD

This invention relates generally to virtual-reality apparatuses and experiential use.

### BACKGROUND

Various shopping paradigms are known in the art. One approach of long-standing use essentially comprises displaying a variety of different goods at a shared physical location and allowing consumers to examine those offerings as they wish to thereby make their purchasing selections. This model is being increasingly challenged.

Increasing efforts are being made to present a given consumer with additional information pertaining to the customer's potential purchase, such as packaging information, advertisements, and other customer reviews. When done properly, this approach can help to provide customers information to ensure that the correct product is purchased or that the customer understands how to properly use the product. That said, existing approaches that permit a customer to examine products and provide testimony from other product users nevertheless leave much to be desired. As a result, while helpful, product examination is inherently very limited in scope and offers only a very weak understanding of the product and the experience of using the product that are relevant to a consumer's satisfaction resulting from the purchase of the product.

### BRIEF DESCRIPTION OF THE DRAWINGS

The above needs are at least partially met through provision of the virtual-reality apparatus described in the following detail description, particularly when studied in conjunction with the drawings, wherein:

FIG. 1 is schematic block diagram in accordance with several embodiments.

FIG. 2 is schematic block diagram in accordance with several embodiments.

FIG. 3 is flow diagram in accordance with several embodiments.

FIG. 4 illustrates an exemplary system for use in implementing systems, apparatuses, devices, methods, techniques and the like in monitoring retail products in a shopping space in accordance with some embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to various embodiments, systems, apparatuses and methods are provided herein useful to provide experiential on-site use of physical retail products within a retail shopping facility in a combined virtual and physical setting. In this manner, a customer may use a physical retail product within the retail shopping facility in an environment simulated to be similar to those typically used or recommended for use with the physical retail product. Thus, for certain items that cannot be easily experienced in a retail shopping facility, the systems, apparatuses, and methods herein provide for a manner of experiencing a physical retail product before purchase. In this manner, the combined virtual-physical experience may serve as a retail marketing system.

In some embodiments, an environment simulation system, disposed within a retail shopping facility, includes a motion simulator configured to simulate movements associated with use of a physical retail product used by a user in a recommended environment within the retail shopping facility, a user interface, and a control circuit. The a user interface may be configured to simulate audio, visual, or haptic aspects of the recommended environment and the use of the physical retail product in that environment, detect user movements, and provide audio, visual, or haptic feedback to the user in response to the detected user movements. By one approach, the control circuit, which is operably coupled to the motion simulator and the user interface, accesses a product simulation database having environment simulation characteristics pertaining to the recommended environment stored therein, analyze the detected user movements in relation to the environment simulation characteristics, and provide instructions to the motion simulator and the user interface regarding the provision of audio, visual, and/or haptic feedback thereby providing interactive use with the retail product such that the motion simulator and the user interface respond to inputs from or actions of the user and provide the user with motion, audio, visual, and/or haptic responses typically attendant the use of the physical retail product in the recommended environment. By one approach, such a configuration allows a customer to virtually utilize a product, e.g., a canoe, kayak, bike, or other such product, while cooperating with and/or wearing a virtual- and/or augmented-reality system.

As used herein, the recommended environment may include the manufacturer's intended real-world environment (i.e., outside of the retail shopping facility) in which a purchaser or customer typically uses the product. In this manner, the recommended environment includes the location and/or setting where the operation or usage of the retail product is designed and/or marketed for its use. For example, a manufacturer of sailing equipment designs products for use on large bodies of water, and thus, that corresponds to the recommended environment.

The term “virtual reality” is typically understood to refer to a substitution of a present local reality for an artificial reality. As used herein, however, references to virtual reality will also be understood to include so-called augmented reality. Augmented reality refers to a live (direct or indirect) view of a physical, real-world environment whose elements are augmented (or supplemented) by computer-generated sensory input such as sound, video, or other sensory content.

To provide sufficient feedback to customers, or users, the environment simulation system typically includes one or more sensors, some of which may be passive sensors. As suggested above, these sensors may be, at least in part, incorporated into the user interface, which also typically provides visual, audio, and/or haptic representations of the recommended environment to the user. Accordingly, the user interface may include a head-mounted audio-visual display, a data suit, a data garment, data eyewear, one or more data gloves, data footwear, data headwear, a touch screen, a graphical user interface, a display screen, one or more digital projectors, spatial augmented reality projectors, one or more speakers, headphones, a haptic feedback device, one or more microphones, a tactile electronic display, and/or an accessory object.

In addition, the physical user product may be used with an accessory object, which may include one or more sensors incorporated therewith. By one approach, the accessory object may include a paddle, a controller, a stick, a game controller, a hand tool, a piece of sports equipment, or a piece of recreational equipment. For example, the sports or recreational equipment may include safety gear or protective wear, such as a personal flotation device or life preserver.

As noted above, to analyze the actions and usage associated with the customer or user, the environmental simulator, including any user interface incorporated therewith, may have one or more sensors. As used herein, the sensors may include a motion sensor, an inertial sensor, an accelerometer, a gyroscope, a digital camera, an optical sensor, a global positioning system sensor, a solid state compass, an RFID tag, a force sensor, or a wireless sensor.

To facilitate simulated environmental use, the environmental simulation system may include a product stand, a treadmill, or an omnidirectional treadmill. In one illustrative example, the product stand, treadmill, and/or omnidirectional treadmill are incorporated into the motion simulator. By one approach, the product stand is configured to receive and securely retain the physical user product for use in the retail shopping facility by the user. To that end, the product stand may have clamps, suction devices, or other mounting hardware. In one example, the motion simulator includes a movement control system that may include one or more actuators, hydraulic cylinders, or a hydraulic lift system configured to move or adjust the physical user product along a normal axis, a lateral axis, and/or a longitudinal axis to simulate use of the physical user product in the recommended environment.

As used herein, both the user interface and the motion simulators may include devices that provide haptic feedback by providing forces, vibrations, and/or motions to the user that simulate characteristics of the recommended environment.

In addition, the environment simulation systems described herein may include an image recording device configured to record the use of the physical user product in the retail shopping facility. This information may be used to help size or adjust the product for the user or may be communicated to the manufacturer to assist with product improvement. Similarly, the environment simulation systems may have a training module in communication with the control circuit facilitating training on the use of the physical user product within the retail shopping facility.

In one illustrative configuration, the environment simulation system provides a user instructional feedback. By one approach, the instructional feedback is provided via the training module. For example, if a user is testing a kayak in the retail environment or retail shopping facility, the training module may provide instructions regarding how to navigate the kayak in the virtual recommended environment, including for example, navigational information, such as direction within the virtual recommended environment, and information regarding handling or use of the kayak and any associated equipment (such as a paddle) to maneuver the kayak as desired.

After using the product on-site at the retail shopping facility and determining proper usage, a customer may be interested in purchasing the particular user product experienced, and therefore, the environment simulation system may have a payment transaction module configured to receive payment for the physical user product.

In operation, the provision of experiential on-site usage of user products in a retail shopping facility is facilitated, in part, by maintaining a product simulation database of unique product identifiers and associated product profiles with simulation data for simulating a recommended environmental use. In this manner, an interested customer may indicate which of the user products they wish to test or experience by providing a unique product identifier to the simulator, which receives the unique product identifier and accesses a product profile associated with the one of the unique product identifiers.

In addition, the system or simulator typically receives the physical user product associated with the one of the unique product identifiers on or in a motion simulator and may then detect, via sensors, such as those associated with a user interface, movements of the user and any movements associated with use of the physical user product and any product accessories used therewith.

The provision of experiential on-site product usage in a retail shopping facility is further facilitated by simulating audio, visual and/or haptic aspects of a particular recommended environmental use associated with the physical user product within a retail shopping facility, analyzing the detected movements of the user and the physical user product and the associated recommended environmental data and simulating data, and instructing the motion simulator to adjust the simulated audio, visual, and/or haptic aspects of the physical user product and simulated environment to thereby provide an interactive use of the physical user product typically associated with usage in the recommended environment.

Further, the process of providing experiential on-site product usage also may include instructing the user interface to adjust the simulated audio, visual and/or haptic aspects in response to the use of the physical user product. In addition, to provide feedback, the user interface may include one or more sensors that measure movement, speed, and/or acceleration of the user, the physical user product, and any product accessories.

During the experiential on-site usage at the retail shopping facility, the method may include recording the use of the physical user product in the environment simulator or motion simulator. Also, these teachings facilitate the provision of recommendations to the user of the physical user product in response to analysis of the recording of the usage.

As suggested above, the system described herein is able to track the customer's on-site usage, such as by monitoring their motions, visual or audio cues, and the like while engaging a physical user product that may be stationary or may be moved or operated according to information in the product simulation database. Accordingly, the systems herein may control visual, audio, and/or haptic feedback provided to the user based on the particular user's movements or responses. Thus, while the product simulation database may provide for movement of the product or user, the visual, audio and haptic feedback is dependent how a particular customer's usage of a product.

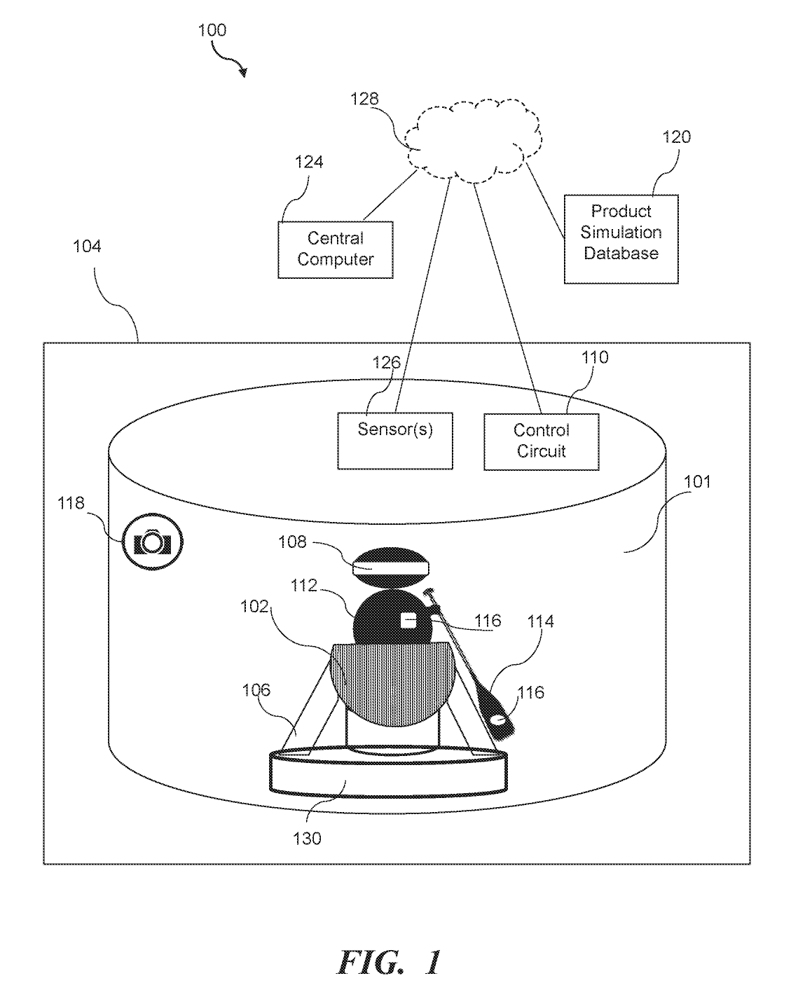

FIG. 1 provides a simple illustrative example in these regards. An environment simulation system 100 may include an environment simulator 101 disposed within a retail shopping facility 104. The environment simulator 101 may include a motion simulator 106 and a user interface 108. By one approach, the motion simulator 106 may be configured to simulate movements, within the retail shopping facility, associated with use of the physical retail product or physical user product by a user in a recommended environment. By another approach, the user interface is configured to simulate audio, visual, and/or haptic aspects of the recommended environment and the use of the physical user product in the recommended environment, detect user movements, and provide audio, visual, and/or haptic feedback to the user in response to the detected user movements or other cues.

As illustrated in FIG. 1, the system 100 also includes a control circuit 110, which is coupled to the motion simulator 106 and the user interface 108. By one approach, the control circuit 110 is configured to access a product simulation database 120 having environment simulation characteristics pertaining to the recommended environment stored therein, analyze the detected user movements in relation to the environment simulation characteristics, and provide instructions to the motion simulator and the user interface regarding the provision of audio, visual, and/or haptic feedback thereby providing interactive use with the user product such that the motion simulator and the user interface respond to inputs from the user and provide the user with motion, audio, visual, and/or haptic responses typically attendant usage of the physical user product in the recommended environment.

The user interface 108 may include a number of different devices or combinations of devices suitable for providing immersive or augmented experiences through the use of different multimedia elements. With these elements, a recommended environment or the environment in which users typically intend to use the product and the presence of the user in that environment may be simulated, but the product itself does not need to be simulated because the real-world physical product is used in combination with the user interface 108.

As used herein, the user interface 108 may include for example, a head-mounted audio-visual display, such as the headset shown in FIG. 1, a data suit, a data garment, data eyewear, one or more data gloves, data footwear, data headwear, a touch screen, a graphical user interface, a display screen, one or more digital projectors, spatial augmented reality projectors, one or more speakers, headphones, a haptic feedback device, one or more microphones, a tactile electronic display, and/or an accessory object. Some of these devices may include hologram technologies. While the user interface 108 may include only one of these devices, in some applications the user interface 108 may include several of these devices. In addition, the user interface 108 may include one or more (sometimes many more) sensors 116 that capture readings on the user's movements and other responses and communicate those to control circuit 110. The sensors 116 may include, for example, a motion sensor, an inertial sensor, an accelerometer, a gyroscope, a digital camera, an optical sensor, a global positioning system sensor, a solid state compass, an RFID tag, a force sensor, or a wireless sensor. For example, the user interface 108 may include a data glove with a force sensor that measures the pressure associated with a user's grip on an accessory object, such as a paddle.

As noted above, the user interface 108 may include an accessory object 114, illustrated in FIG. 1 as a canoe paddle, with a sensor 116. The accessory object 114 may include one or more sensors 116 that are in communication with the control circuit 110. In addition to the paddle, the accessory object may include a controller, a stick, a game controller, a hand tool, a piece of sports equipment, or a piece of recreational equipment.

In addition to sensing the actions of the user 112 in the simulator 101, the user interface 108 may provide visual, audio, and/or haptic aspects of the recommended environment. Further, in one illustrative example, a haptic feedback device incorporated into the simulator 101 is configured to simulate characteristics of the recommended environment by providing at least one of forces, vibrations, or motions to the user. By one approach, the sensors 116 obtain readings on the user's response to the visual, audio, and/or haptic aspects simulated for the user 112, thereby quantifying the user's response to the visual or—augmented reality created during usage of the product 102. Further, while some of the sensors 116, such as some passive sensors, may be mounted onto the product 102, user 112, or accessory object 114, other sensors 126 may be otherwise mounted within the simulator 101.

In some implementations, movement of the product can be controlled through a movement control system that can change an amount of pitch, roll, or yaw in cooperation with the visual and/or audio content to provide a more realistic virtual- or augmented-experience.

In addition to a user interface 108, the environment simulator 101 also may include a motion simulator 106 configured to simulate movements, within the retail shopping facility, associated with use of the physical user product by a user in a recommended environment. For example, if the user product is a canoe, the motion simulator 106 may simulate or create the feel of moving the canoe over water, downstream, or over/through water rapids by recreating the feeling a user has when the canoe rides over waves.

In one embodiment, the motion simulator 106 may include a product stand, a treadmill, or an omnidirectional treadmill. The product stand 130, illustrated in FIG. 1, may be configured to receive and secretly retain the physical user product for use in the retail shopping facility by the user. To that end, the product stand may have clamps, suction devices, or other mounting hardware. The product stand 130 not only helps effect movement of the product 102 therein, but prevents the product 102 from being damaged during the simulation of the intended or recommended environment.

By one approach, the motion simulator 106 includes a movement control system and includes one or more actuators, hydraulic cylinders, or a hydraulic lift system configured to adjust the physical user product along a normal axis, a lateral axis, and/or a longitudinal axis to simulate use of the physical user product in the recommended environment. In this manner, the motion simulator 106 is configured to simulate or create the feeling of using the product 102 in its intended or recommended environment.

The motion simulator 106 may include a haptic feedback system configured to simulate characteristics of the recommended environment by providing at least one of forces, vibrations, or motions to the user, this may be in addition to or in conjunction with a haptic feedback device of the user interface 108. In one illustrative approach, the motion simulator 106 simulates or creates the feeling of using the product 102 in the intended environment and then adjusts forces, vibrations, or motions provided to the user 112 based on the sensed actions of the user 112. This real-time feedback permits a user to experience using the product 102 as they might use the product in the real, physical world outside of the retail shopping facility 104.

In this manner, the system 100 enables marketing of products by combining real use of products within virtual environments and physical simulators. Accordingly, a user 112 that is interested in experiencing the use of a retail product 102 may scan a product identifier, such as by a Universal Product Code (UPC) or other product code. The control circuit 110 of the environment simulator 101 may then access the product simulation database 120 to pull product information and simulation data for simulating a recommended environmental use. By one approach, the simulator 101 will include a product stand 130 that may be designed to facilitate simulation of the intended environment. For example, the simulator 101 may have a product stand 130 configured to receive a canoe such as by having suction devices configured to attach to the body of the canoe and these suction devices may be associated with hydraulic cylinders of the motion simulator 106 to create the movement of water that the canoe will typically experience during usage in the recommended environment.

The motion simulator 106 and user interface 108, together, may create or simulate the motions associated with the heat, wind, and water experienced during use of the canoe. Further, the motion simulator 106 and the user interface 108 of the simulator 101 may provide numerous different environmental recreations or simulations. In this manner, the user may experience white water rafting, floating down a calm river, or paddling out into ocean scenes to view marine wildlife. In this way, a customer can experience several different environments that may be experienced when using the product 102. Furthermore, the simulated experience may be gauged to a particular use's experience level.

In addition, the simulator 101 may adjust the environment based on the user product 102 being experienced. For example, the control circuit 110 may simulate the experience of white water rapids if the product 102 being experienced or tested is a kayak, but may simulate the experience of floating and/or fishing on a calm lake for a canoe.

As noted above, the user interface 108 may include various virtual- or augmented-reality technology, such as a headset to provide additional aspects of the experience. By one approach, the use of a motion capture or haptic system allows the control circuit 110 to input or make adjustments for resistance and weight. For example, if the user product 102 is a canoe that is used with a paddle, the user interface 108 may be configured to provide resistance to the paddle. In other configurations, the user interface 108 may be configured to splash the user or otherwise get the user wet with mist or water spray. This tactile feedback not only helps the user evaluate the product, but also provides a nice experiential use that may be particularly appealing to potential purchasers.

The environment simulator 101 also may include an image recording device that records usage of the physical user product 102 in the retail shopping facility 104. This may facilitate the provision of additional feedback to both the user 112 and the manufacturer of the products 102. The image recording device 118 may include a video recorder that captures a potential customer's use of the retail product 102. It might be useful to capturing reactions that users 112 have to the simulated experience and to capture their actions during simulation to better understand consumers and how they use products. Furthermore, such recordings might help identify which products are easily used together when compared with other recorded simulations.

The image recording device 118 also may be used to provide feedback to the vendors or manufactures of the product so that they better understand how customers and users interact with the product. To that end, the control circuit 110 may be in communication with a central computer 124 that is in communication with several retail shopping facilities 104 that may accumulate or compile data from several simulators 101.

By way of example, if a user, sitting in a canoe constantly needs to move their weight around, this could be an indication that the seat within the canoe is extremely uncomfortable for a user of that size, or if the user is frequently resituating their hands on the paddle, it might indicate that the paddle is too heavy or awkward for proper use. Alternatively, the seat may be incorrectly positioned for the user's size and the paddle may not be proper for use with a particular craft. To help the vendors and manufacturers determine the source of a user's concern, they might analyze data compiled from numerous testers or users having experienced the product 102 in a simulated environment to determine whether position/configuration, usage, or design of the product are the source of a user's dissatisfaction and/or discomfort.

The system 100 also may include a training module in communication with the control circuit 110 that facilitates training on the use of the physical user product 102 within the retail shopping facility 104. For example, the training module may introduce the user 112 to aspects of the product 102 and begin by providing instructions for use of the product 102. In another example, the training module may be configured to expose the user 12 to a relatively moderate environmental experience at the beginning of the simulation, but may proceed to provide a more challenging environment upon successful completion of a certain amount of practice or time in the simulator 101.

In addition, the image recording device 118, along with the training module, may be used to coach or teach users how to properly use a product, to recommend a different size product, etc. The training module and the recording device 118 can provide real-time feedback that provides users with a better understanding of the product and how to use the product. The user also may be informed of their level of performance, which can be particularly valuable information when customer's leave the retail shopping facility.

In addition, the control circuit 110 may be able to recommend or identify accessory objects that may be useful or adjustments that may be of assistance. For example, if a customer is experiencing or using a kayak in the simulator 101, the control circuit 110 may determine that a differently sized or designed life jacket or other flotation device may make use of the paddle easier. This determination may be based on information received from the image recording device 118 and/or sensor 116, 126. In this manner, the user experiences using the canoe in a manner similar to the real, physical world outside of the retail shopping facility and the user gets valuable information regarding how to use the canoe and possibly information regarding use, arrangement, or size of the product and any accessory objects used therewith without having to have purchased the item.

After or during their experiential on-site use of the product 102, the user may decide they want to buy the product 102 and may provide payment therefore. In this manner, the system may further include a payment transaction module configured to receive payment for the product in the retail shopping facility.

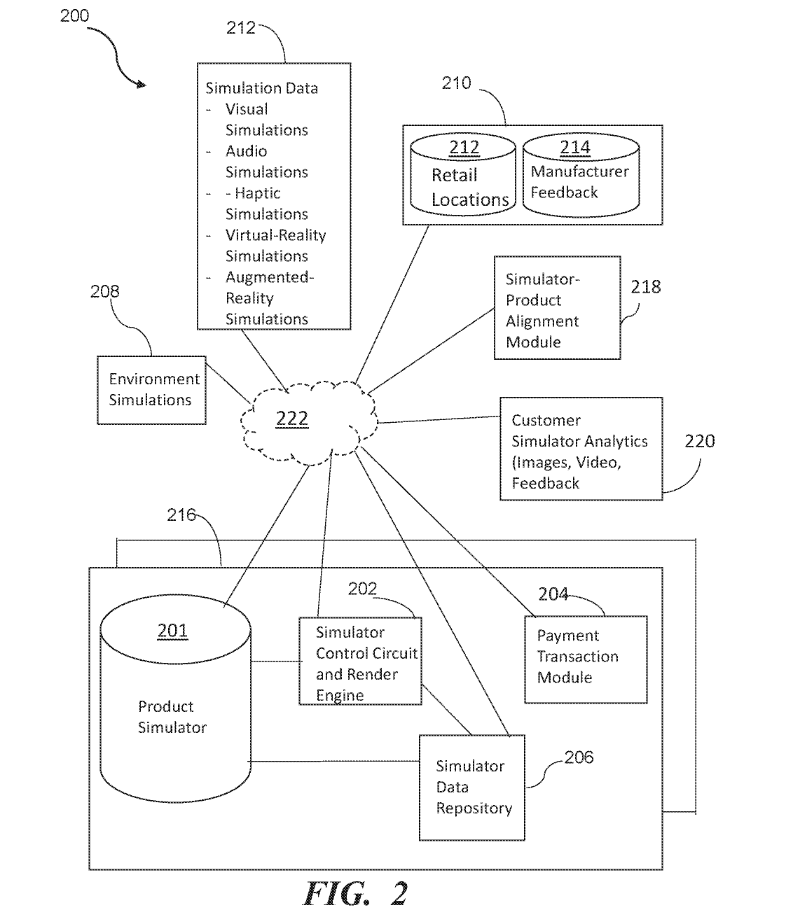

FIG. 2 illustrates another system 200 is similar to system 100, and further illustrates various additional elements that help facilitate a retail shopping facility 216 providing experiential on-site use of numerous different physical products. To that end, the product simulator 201 (which may include a motion simulator and/or user interface similar to those discussed above) may be connected, via a network 222, to a database of environment simulations 208, a simulator-product alignment module 218, a customer simulator analytics module 220, and a retail locations simulation database 212. The retail locations simulation database 212 may include, for example, visual simulations, audio simulations, virtual-reality simulations, and augmented-reality simulations that help the product simulator 201 recreate the environment as outlined or captured in the environment simulation database 208. By storing these components outside of the physical retail shopping facilities 216, they may be more easily updated to include changes to simulations or simulation data for additional products.

The product simulator 201 also may be in communication with a headquarters or central computer 210 that may store information regarding simulation data for different retail locations, via the retail locations simulation database 212, and information or feedback 214, to be provided to vendors or manufacturers.

Within the retail shopping facility 216, the system 200 may include a simulator control circuit and render engine 202, a simulator data repository 206, and a payment transaction module 204, similar to those described above. The simulator data repository 206 may periodically access and/or download data from other databases, such as, for example, the environment simulations database 208 or the simulation database 212, but the simulator data repository 206 may be stored locally to facilitate easy and quick access to the data stored therein by the product simulator 201 and/or the simulator control circuit and render engine 202.

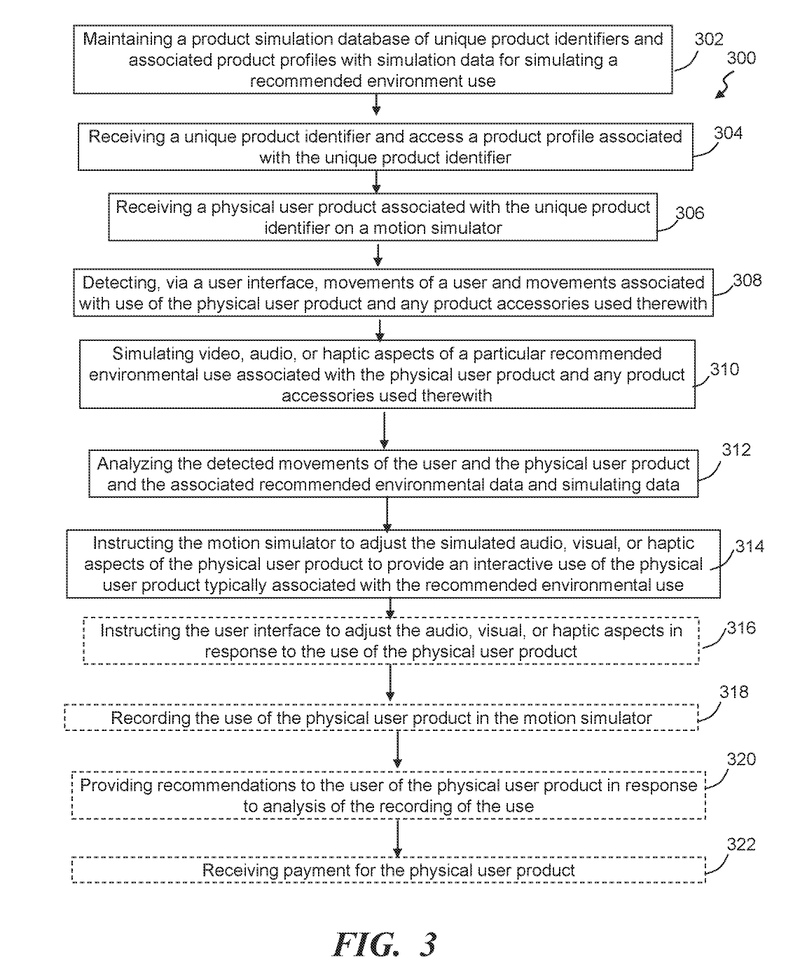

Turning now to FIG. 3, a process 300 is illustrated for providing experiential on-site use of physical retail products. By one approach, the method 300 includes maintaining 302 a product simulation database of unique product identifiers and associated product profiles with simulation data for simulating a recommended environmental use.

In step 304, the process includes receiving a unique product identifier and accessing a product profile associated with the unique product identifiers. In this manner, the simulator obtains data that corresponds to the recommended environment that a user typically intends to use the product. Further, the data will not only include information on how any canoe or watercraft might respond to various forces while being used in a certain environment, but will include information on how the particular canoe would operate or respond to certain inputs or actions of a user during usage. The data also will include information regarding how the simulator can recreate the recommended environment with the motion simulator and user interface used therewith.

The method 300 also includes receiving 306 a physical user product associated with the unique product identifier on a motion simulator. In this manner, the physical user product can be mounted upon actuators, such that it can be controlled relative to a virtual world simulation that interacts with a user based on their movements and inputs. As noted above, the motion simulator may be configured to simulate motions attendant a recommended use and also may respond to a user's movements and inputs.

To that end, in step 308, the method detects, via a user interface, the movements of a user, the movements associated with use of the physical user product and the movements of any product accessories used therewith. By one approach, a user may physically sit in a canoe and participate in a virtual experience of the physical canoe heading downstream through, for example, a virtual river or over a virtual lake using a head-mounted audio-visual display, such as virtual 3D goggles. This virtual experience may be further facilitated by actuators configured to control the pitch, roll, and/or yaw of the actual, physical canoe.

Accordingly, the method 300 also includes simulating 310, within the retail shopping facility, at least one of audio, visual and/or haptic aspects of a particular recommended environmental use associated with the physical user product. The provision of such simulation may be facilitated by, for example, the motion simulator 106 and/or the user interface 108 discussed above.

The method 300 also includes analyzing 312 the detected movements of the user and the physical user product and the associated recommended environmental data and simulating data. Further, in an exemplary approach, the method includes instructing 314 the motion simulator to adjust the at least one of the simulated audio, visual, and/or haptic aspects of the physical user product to thereby provide an interactive use of the physical user product typically associated with the recommended environmental use. As noted above, the simulation of the audio, visual, and/or haptics aspects of a particular recommended environment for a physical user product may be facilitated by the user interface 108 and/or the motion simulator 106 discussed above. In one illustrative approach, the user interface 108 comprises one or more sensors and the method further includes measuring the movement, speed, and/or acceleration of the user, the physical user product, and any accessories associated therewith.

In addition, the method 300 may include instructing 316 the user interface to adjust the simulated audio, visual and/or haptic aspects in response to the use of the physical user product.

In step 318, the method may include recording the use of the physical user product in the environmental simulator and/or the motion simulator. As mentioned above, this recording may be particularly valuable to those learning to use the product, those who may need assistance sizing or setting up the product, and/or manufacturers of the product.

By another approach, the method 300 includes providing 320 recommendations to the user of the physical user product in response to analysis of their simulated environmental usage. The recommendations may be, for example, the use of a different accessory object, adjustments to the size or configuration of the product, and/or adjustments to the use itself, among others.

In step 322, the method includes receiving payment for the physical user product. This may be particularly valuable for consumers who wish to continue training or use of the product after an initial experimental on-site use.

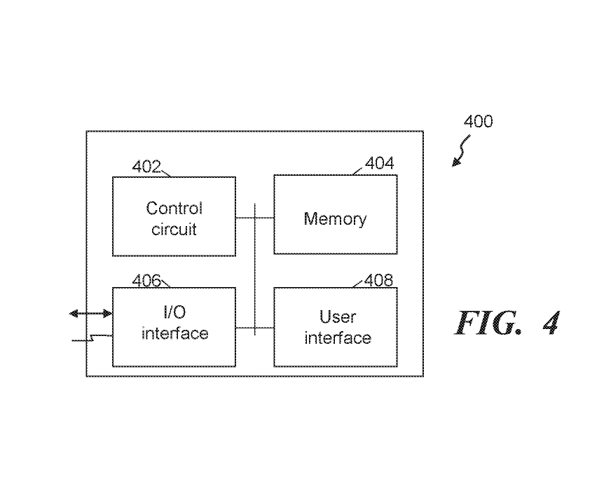

The methods, techniques, systems, devices, services, servers, sources and the like described herein may be utilized, implemented and/or run on many different types of devices and/or systems. Referring to FIG. 4, there is illustrated a system 400 that may be used for any such implementations, in accordance with some embodiments. One or more components of the system 400 may be used to implement any system, apparatus or device mentioned above or below, or parts of such systems, apparatuses or devices, such as for example any of the above or below mentioned environmental simulation systems, simulators, user interfaces, databases, devices, parts thereof, and the like. However, the use of the system 400 or any portion thereof is certainly not required.

By way of example, the system 400 may include one or more control circuits 402, memory 404, and input/output (I/O) interfaces and/or devices 406. Some embodiments further include one or more user interfaces 408. The control circuit 402 typically comprises one or more processors and/or microprocessors. The memory 404 stores the operational code or set of instructions that is executed by the control circuit 402 and/or processor to implement the functionality of the systems and devices described herein, parts thereof, and the like. In some embodiments, the memory 404 may also store some or all of particular data that may be needed to analyze images of store shelves and determine whether restocking is need or whether the store shelves closely resembled the planogram.

It is understood that the control circuit 402 and/or processor may be implemented as one or more processor devices as are well known in the art. Similarly, the memory 404 may be implemented as one or more memory devices as are well known in the art, such as one or more processor readable and/or computer readable media and can include volatile and/or nonvolatile media, such as RAM, ROM, EEPROM, flash memory and/or other memory technology. Further, the memory 404 is shown as internal to the system 400; however, the memory 404 can be internal, external or a combination of internal and external memory. Additionally, the system typically includes a power supply (not shown), which may be rechargeable, and/or it may receive power from an external source. While FIG. 4 illustrates the various components being coupled together via a bus, it is understood that the various components may actually be coupled to the control circuit 402 and/or one or more other components directly.

Generally, the control circuit 402 and/or electronic components of the system 400 can comprise fixed-purpose hard-wired platforms or can comprise a partially or wholly programmable platform. These architectural options are well known and understood in the art and require no further description here. The system and/or control circuit 402 can be configured (for example, by using corresponding programming as will be well understood by those skilled in the art) to carry out one or more of the steps, actions, and/or functions described herein. In some implementations, the control circuit 402 and the memory 404 may be integrated together, such as in a microcontroller, application specification integrated circuit, field programmable gate array or other such device, or may be separate devices coupled together.

The I/O interface 406 allows wired and/or wireless communication coupling of the system 400 to external components and/or or systems. Typically, the I/O interface 406 provides wired and/or wireless communication (e.g., Wi-Fi, Bluetooth, cellular, RF, and/or other such wireless communication), and may include any known wired and/or wireless interfacing device, circuit and/or connecting device, such as but not limited to one or more transmitter, receiver, transceiver, etc.

The user interface 408 may be used for user input and/or output display, such as the display of the simulator 101 that an associate at the retail shopping facility will manipulate to provide the simulated experience to the user. For example, the user interface 408 may include any known input devices, such one or more buttons, knobs, selectors, switches, keys, touch input surfaces, audio input, and/or displays, etc. Additionally, the user interface 408 include one or more output display devices, such as lights, visual indicators, display screens, etc. to convey information to a user, such as but not limited to communication information, status information, notifications, errors, conditions, and/or other such information. Similarly, the user interface 408 in some embodiments may include audio systems that can receive audio commands or requests verbally issued by a user, and/or output audio content, alerts and the like.

Those skilled in the art will recognize that a wide variety of other modifications, alterations, and combinations can also be made with respect to the above described embodiments without departing from the scope of the invention, and that such modifications, alterations, and combinations are to be viewed as being within the ambit of the inventive concept.

What is claimed is:

1. An environment simulation system comprising:
a physical user product within a retail shopping facility;
a motion simulator configured to simulate movements associated with use of the physical user product by a user in a recommended environment within the retail shopping facility;
a user interface configured to:
simulate at least one of audio, visual, or haptic aspects of the recommended environment and the use of the physical user product in the recommended environment,
detect user movements, and
provide at least one of audio, visual, or haptic feedback to the user in response to the detected user movements;
a control circuit operably coupled to the motion simulator and the user interface, the control circuit configured to:
access a product simulation database having environment simulation characteristics pertaining to the recommended environment stored therein;
analyze the detected user movements in relation to the environment simulation characteristics; and
provide instructions to the motion simulator and the user interface regarding the provision of the at least one of audio, visual, or haptic feedback thereby providing interactive use with the user product such that the motion simulator and the user interface respond to inputs from the user and provide the user with motion, audio, visual, and haptic responses typically attendant the use of the physical user product in the recommended environment.

2. The environment simulation system of claim 1 wherein the user interface comprises at least one of: a head-mounted audio-visual display, a data suit, a data garment, data eyewear, one or more data gloves, data footwear, data headwear, a touch screen, a graphical user interface, a display screen, one or more digital projectors, spatial augmented reality projectors, one or more speakers, headphones, a haptic feedback device, one or more microphones, a tactile electronic display, or an accessory object.

3. The environment simulation system of claim 2 wherein the accessory object includes one or more sensors incorporated therewith.

4. The environment simulation system of claim 3 wherein the accessory object comprises at least one of: a paddle, a controller, a stick, a game controller, a hand tool, a piece of sports equipment, or a piece of recreational equipment.

5. The environment simulation system of claim 2 wherein the user interface comprises one or more user sensors incorporated therein including at least one: motion sensor, inertial sensor, accelerometer, gyroscope, digital camera, optical sensor, global positioning system sensor, solid state compass, RFID tag, a force sensor, or wireless sensor.

6. The environment simulation system of claim 2 wherein the haptic feedback device of the user interface is configured to simulate characteristics of the recommended environment by providing at least one of forces, vibrations, or motions to the user.

7. The environment simulation system of claim 1 wherein the motion simulator comprises at least one of: a product stand, a treadmill, or an omnidirectional treadmill.

8. The environment simulation system of claim 7 wherein the product stand is configured to receive and securely retain the physical user product for use in the retail shopping facility by the user.

9. The environment simulation system of claim 1 wherein the motion simulator comprises a movement control system and includes one or more actuators, hydraulic cylinders, or a hydraulic lift system configured to adjust the physical user product along at least one of a normal axis, a lateral axis, or a longitudinal axis to simulate use of the physical user product in the recommended environment.

10. The environment simulation system of claim 1 wherein the motion simulator further comprises a haptic feedback system configured to simulate characteristics of the recommended environment by providing at least one of forces, vibrations, or motions to the user.

11. The environment simulation system of claim 1 further comprising an image recording device configured to record the use of the physical user product in the retail shopping facility.

12. The environment simulation system of claim 1 further comprising a payment transaction module configured to receive payment for the physical user product.

13. The environment simulation system of claim 1 further comprising a training module in communication with the control circuit facilitating training on the use of the physical user product within the retail shopping facility.

14. A method of providing on-site experiential use in a physical retail shopping facility comprising:
maintaining a product simulation database of unique product identifiers and associated product profiles with simulation data for simulating a recommended environmental use;
receiving one of the unique product identifiers and accessing a product profile associated with the one of the unique product identifiers;
receiving a physical user product associated with the one of the unique product identifiers on a motion simulator;
detecting, via a user interface, movements of a user and movements associated with use of the physical user product and any product accessories used therewith;
simulating at least one of audio, visual or haptic aspects of a particular recommended environmental use associated with the physical user product within a retail shopping facility;
analyzing the detected movements of the user and the physical user product and the associated recommended environmental data and simulating data; and
instructing the motion simulator to adjust the at least one of the simulated audio, visual, or haptic aspects of the physical user product to thereby provide an interactive use of the physical user product typically associated with the recommended environmental use.

15. The method of claim 14 wherein the simulation of the at least one of audio, visual, or haptic aspects of the particular recommended environmental use associated with the physical user product occurs via the user interface and the motion simulator.

16. The method of claim 14 further comprising instructing the user interface to adjust the at least one of the simulated audio, visual or haptic aspects in response to the use of the physical user product.

17. The method of claim 14 wherein the user interface comprises one or more sensors and the method further includes measuring at least one of: movement, speed, or acceleration of the user, the physical user product, and the any product accessories associated therewith.

18. The method of claim 14 further comprising recording the use of the physical user product in the motion simulator.

19. The method of claim 18 further comprising providing recommendations to the user of the physical user product in response to analysis of the recording of the use.

20. The method of claim 14 further comprising receiving payment for the physical user product.
